(19) United States
(12) Patent Application Publication
(10) Pub. No.: US 2016/0144301 A1
(43) Pub. Date: May 26, 2016

(54) MODULAR MULTIMEDIA FLUID TREATMENT SYSTEM

(71) Applicants: JOHN W. TADLOCK, West Chicago, IL (US); Angelo Flamingo, Ottawa, IL (US); Cheryl L. Panasik, Elburn, IL (US)

(72) Inventors: JOHN W. TADLOCK, West Chicago, IL (US); Angelo Flamingo, Ottawa, IL (US); Cheryl L. Panasik, Elburn, IL (US)

(21) Appl. No.: 14/550,601

(22) Filed: Nov. 21, 2014

(51) Int. Cl. B01D 29/52

(52) U.S. Cl. CPC B01D 29/52

(57) ABSTRACT

A modular multimedia fluid treatment system of the manifold type is disclosed wherein fluids, to be treated, are conducted into a first end of a manifold, conducted through a plurality of treatment cartridges, and end-use fluid is conducted out from a second opposite end of the manifold of the fluid treatment system. While the present invention is described and illustrated in conjunction with treating water, the general overall structure of the present invention may of course be utilized in conjunction with the treatment of fluids other than water. In addition, the unique modular characteristics of the system are applicable to those systems utilizing one or more fluid treatment cartridges.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### INCORPORATION BY REFERENCE OF MATERIAL SUBMITTED ON A COMPACT DISC

Not Applicable

### FIELD OF THE INVENTION

The present invention relates generally to fluid treatment systems, and more particularly to a new and improved modular multimedia fluid treatment system of the manifold type wherein fluids, to be treated, are conducted into a first end of a manifold, conducted through a plurality of treatment cartridges, and end-use fluid is conducted out from a second opposite end of the manifold of the fluid treatment system. While the present invention is described and illustrated in conjunction with treating water, the general overall structure of the present invention may of course be utilized in conjunction with the treatment of fluids other than water, such as, for example, cooking oils, medical fluids, coolants, lubricants, and the like.

### BACKGROUND OF THE INVENTION

Many conventional fluid treatment systems are of the manifold type wherein, generally, a fluid, to be treated, is conducted into a first end of the manifold, conducted through one or more treatment cartridges comprising the system, and treated, useful fluid is then conducted out from a second opposite end of the manifold. In order to remove or replace one or more of the treatment cartridges, as may be necessary in order to perform various different fluid treatment processes, or in order to replace worn or exhausted cartridges, the system must contain a multiplicity of shut-off control valves in order to effectively isolate the system such that a particular one of the cartridges can in fact be removed and replaced without inadvertently disgorging fluid from the system or inadvertently depriving other sub-systems of the overall system, or other equipment downstream from the fluid treatment system, of necessary fluid. The problem with such conventional systems, however, is that such shut-off control valves are often located remotely from the fluid treatment system. Accordingly, service personnel must travel from the fluid treatment site to the site or location at which such shut-off control valves are located, locate the particular shut-off control valve to be closed in order to in fact isolate the system in order to permit other service personnel to remove and replace the particular cartridge which is to be removed or replaced, and then re-open the shut-off control valve once the particular cartridge has in fact been removed and replaced. It can therefore be appreciated that a considerable amount of time is wasted performing such necessary service operations. In addition, either a multiple number of personnel are required for operating the shut-off control valves and for performing the removal and replacement of the particular cartridge, or alternatively, the same personnel can perform both jobs, however, that would, of course, entail even more time, wherein, for example, such service personnel would have to travel from the fluid treatment site to the site or location at which the shut-off control valves are located such that the particular shut-off control valve can in fact be closed, travel back to the fluid treatment site, remove and replace the particular cartridge, and then travel back to the site or location at which the shut-off control valves are located so as to again open such shut-off control valve in order to effectively bring the fluid treatment system back on line. Furthermore, due to the presence of a multiplicity of shut-off control valves, special care must be taken by such service personnel in order to in fact locate and close the particular or correct one of the shut-off control valves, otherwise, when the particular cartridge is to be removed and replaced, the fluid treatment system will not in fact be properly isolated whereby the foregoing undesirable disgorging of the system fluid will occur. In addition, if the incorrect shut-off control valve is closed, fluid can be undesirably shut off to sensitive equipment which can result in substantial damage to the system or other equipment. Still yet further, in conventional systems that do not employ backwashing or backflushing capabilities in connection with their prefilters or upstream filtering components, such filters can become clogged, thereby reducing fluid flow throughout the system, adversely affecting equipment downstream from the fluid treatment system, and necessitating the replacement of such filter structures which is both costly and time-consuming.

Another problem encountered in connection with the use of conventional cartridges within conventional fluid treatment systems resides in the fact that such cartridges are substantially large and heavy, especially when they contain fluids. Accordingly, the cartridges are bulky and difficult to handle, and since some fluids may have accumulated upon the exterior surface portions of the cartridges, as a result, for example, of having exchanged or replaced one or more of the cartridges, they become slippery and even more difficult to handle. These conditions can potentially serve as safety hazards for service personnel. Furthermore, the cartridges usually require special tools to be utilized in connection with the disconnection and removal, or installation and connection, of the cartridges both from and within the fluid treatment system.

A need therefore exists in the art for a new and improved modular multimedia fluid treatment system wherein a plurality of modular fluid treatment cartridges can be quickly and easily mounted upon, and removed from, a manifold within which the various fluid flow paths are defined. In addition, automatically operated shut-off control valves must be integrally incorporated within the manifold such that when a particular cartridge is to be removed from the manifold and the fluid treatment system, an inadvertent discharge of fluid does not occur. In addition, only that portion of the system is effectively shut down or isolated such that no collateral damage is effectuated upon other operative components of the fluid treatment system or upon other equipment located downstream from the fluid treatment system. Furthermore, the fluid treatment system needs to have backwashing or reverse flushing capabilities built into it such that the prefilter cartridge can be periodically cleaned such that the prefilter cartridge does not become clogged. Still yet further, the cartridges must have structure defined upon their external surface portions so as to effectively enhance the easy and ensured safe handling of the cartridges by service personnel even when such external surface portions may become wet as a result of fluids accumulating upon such external surface portions of the cartridges from previous handling of the cartridges during cartridge disconnection, removal, exchange, replacement, connection, and installation procedures by service personnel.

### SUMMARY OF THE INVENTION

The foregoing and other objectives are achieved in accordance with the teachings and principles of the present invention through the provision of a new and improved modular multimedia fluid treatment system which comprises a manifold structure within which the various fluid flow paths are defined. A plurality of modular cartridges, comprising, for example, a prefilter cartridge, a fluid storage cartridge, and a chemical reduction/fluid treatment cartridge, are mounted upon a plurality of head members, incorporated within the manifold, in a snap-fitted manner. The plurality of modular cartridges can be easily and assuredly installed upon, and removed from, the head members of the manifold by means of quarter-turn locking mechanisms which comprise a pair of diametrically opposed locking lugs, integrally mounted upon each one of the cartridges, and a pair of diametrically opposed locking ledges integrally formed upon each one of the head members with which the pair of diametrically opposed locking lugs of the cartridges are adapted to engage when the cartridges are disposed at their locked positions upon the head members. In this manner, the need for auxiliary tools and fasteners is obviated. In addition, each one of the head members has a pair of oppositely disposed spring biased control check valves incorporated therein for effectively controlling the flow of fluid through its portion of the manifold. The cartridges are also provided with substantially elliptically configured cam members such that when a particular cartridge is disposed, relative to its head structure, at a position at which it can be mounted upon or removed from the particular head member, the elliptical cam member of the cartridge has its minor axis coaxially aligned with a locus extending between the pair of oppositely disposed control check valves. In this manner, the elliptical cam member does not engage the pair of oppositely disposed control check valves whereby the spring-biased control check valves are disposed at their CLOSED positions. Conversely, when the particular cartridge is rotated 90°, the pair of diametrically opposed locking lugs disposed upon the particular cartridge engage the pair of diametrically opposed locking ledges disposed upon the particular head member such that the particular cartridge is now securely mounted upon the particular head member. In addition, the elliptical cam member has likewise been rotated 90° whereby its major axis is now coaxially aligned with the locus extending between the pair of oppositely disposed control check valve such that the oppositely disposed longitudinally spaced ends of the elliptical cam member engage the pair of oppositely disposed control check valves whereby the spring-biased control check valves are moved to their OPEN positions. Accordingly, it can be appreciated further that when the particular one of the cartridges is disconnected from the particular one of the head members of the manifold, the shut-off control check valves are automatically moved to their CLOSED positions. In this manner, no leakage of fluid is able to occur.

In addition, in furtherance of the modular construction of the fluid treatment system, not only are the plurality of fluid treatment cartridges modular, readily removable, and readily connectable to the plurality of head members, but the entire manifold structure, comprising the plurality of head members, is likewise modular. More particularly, a first end connector, having a fluid inlet port defined therein, is snap-fitted into a first side portion of the first head member within which, For example, the first prefilter cartridge is mounted, and a first side portion of a first intermediate connector is then mated, in a snap-fitted manner, into the second opposite side portion of the first head member. A second opposite side of the first intermediate connector is then mated, in a snap-fitted manner, into a first side portion of the second head member within which the fluid storage cartridge is mounted, and a first side portion of a second intermediate connector is then mated, in a snap-fitted manner, into the second opposite side portion of the second head member. Continuing further, a second opposite side of the second intermediate connector is then mated, in a snap-fitted manner, into a first side portion of the third head member within which the chemical reduction media cartridge is mounted, and a second end connector, having a fluid outlet port defined therein, is then mated, in a snap-fitted manner, into the second opposite side portion of the third head member, thereby completing the construction of the fluid treatment system manifold. Furthermore, backwashing or reverse flushing capabilities are provided within the fluid treatment system so as to effectively ensure that the prefilter cartridge is maintained clean whereby unimpeded fluid flow through the system is assured. Still yet further, each one of the external surface portions of each one of the plurality of cartridges is provided with longitudinally oriented ribbed structures which provide tactile surface portions which facilitate the safe handling of the cartridges even if or when such external surface portions of the cartridges become wet. It is to be noted still further that, alternatively, only a single cartridge may comprise the fluid treatment system in order to satisfy the particular use or need of such a system, such as, for example, for removing chlorine from water, or to render lake water safe for drinking. Furthermore, the fluid treatment system may comprise only a pair of cartridges comprising, for example, the prefilter cartridge and the chemical reduction or fluid treatment cartridge, the fluid storage cartridge having effectively been eliminated because in lieu of needing to backwash or reverse flush the prefilter cartridge, one may simply choose to replace the prefilter cartridge at a time when its known service life limit is approaching. Still yet further, while the various cartridges can effectively be connected in series with respect to each other, wherein, for example, the output from one cartridge is routed so as to flow into the next cartridge, one or more cartridges may be arranged in parallel with respect to each other wherein fluid, to be treated, is simultaneously conducted through the one or more cartridges and then their combined output is, for example, combined so as to flow into a final treatment cartridge. These various embodiments add variability and versatility to the disclosed modular multimedia fluid treatment system.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic cross-sectional view of a first embodiment of a new and improved modular multimedia fluid treatment system constructed in accordance with the principles and teachings of the present invention;

FIG. 2 is a perspective view of the new and improved modular multimedia fluid treatment system as disclosed within FIG. 1;

FIG. 3 is a perspective view, similar to that of FIG. 2, but somewhat enlarged, so as to more clearly illustrate some of the structural component details comprising the modular multimedia fluid treatment system, particularly the connection of the various components comprising the manifold of the system;

FIG. 4 is a perspective view, similar to that of FIG. 1, but somewhat enlarged, so as to more clearly illustrate some of the structural component details comprising the modular multimedia fluid treatment system, particularly the connection of the various components comprising the manifold of the system;

FIG. 5 is a schematic perspective view of one of the end connectors which can serve either as the first fluid inlet connector or the second fluid outlet connector;

FIG. 6 is a schematic perspective view of one of the intermediate connectors which can effectively serve either as the flush valve assembly connector or the flow direction connector;

FIG. 7 is effectively a cross-sectional view of one end of one of the connectors illustrating how the end of the connector is snap-fitted into one side portion of one of the manifold heads;

FIG. 8 is a schematic cross-sectional view illustrating the mounting of the first and second fluid inlet and fluid outlet connectors upon a manifold head when utilized, for example, within a second embodiment fluid treatment system which comprises the use of only a single fluid treatment cartridge;

FIG. 9 is a schematic perspective view of the upper portion of one of the prefilter or chemical reduction/fluid treatment cartridges illustrating the quarter-turn locking mechanism for mounting the particular cartridge onto one of the head members, as well as the elliptical cam member for engaging the check valves within the head members in order to move the check valves to their OPEN positions when the cartridge is mounted upon the head member;

FIG. 10 is a bottom plan view of one of the head members wherein there is illustrated the disposition of the pair of oppositely disposed check valves which are shown in their CLOSED positions in view of the fact that a cartridge is not connected to the head member;

FIG. 11 is a top perspective view, with the upper head structure removed, showing, for example, the mounting of the prefilter cartridge upon the head member whereby the elliptical cam member has been oriented so as to engage the diametrically opposed spring-biased check valves in order to move the check valves from their CLOSED positions, illustrated within FIG. 10, to their OPEN positions so as to permit fluid flow therethrough;

FIG. 12 is a bottom plan view, similar to that of FIG. 10, illustrating, from a different perspective, the pair of diametrically opposed check valves mounted within the head member and disposed at their CLOSED positions, as well as the quarter-turn locking ledge structures of the head member for cooperating with the quarter-turn locking lugs of the cartridge;

FIG. 13 is a perspective view, similar to that of FIG. 9, illustrating, from a different perspective, the upper portion of the prefilter or the chemical reduction/fluid treatment cartridges comprising the quarter-turn locking mechanism for mounting the particular cartridge onto one of the head members, as well as the elliptical cam member for engaging the check valves within the head members in order to move the check valves to their OPEN positions when the cartridge is mounted upon the head member;

FIG. 14 is a perspective view of one of the cartridge housings illustrating the external surface portion of the housing wherein the same is provided with cut-out regions within which ribbed inserts can be inserted so as to provide the cartridges with enhanced tactile surface discontinuities for facilitating the safe handling of the cartridges even when wet;

FIG. 15 is a perspective view of one of the ribbed inserts to be inserted into one of cut-out regions formed within the external surface portions of the cartridges as illustrated within FIG. 14;

FIG. 16 is a perspective view of the interior of the prefilter cartridge showing a multiplicity of elongated filter members disposed within the cartridge and through which the incoming fluid to be treated must flow so as to be filtered and discharged through means of the upstanding discharge tube located coaxially within the prefilter cartridge;

FIG. 17 is a perspective view of a bundle of the filter members, as illustrated within FIG. 16, banded together so as to form the composite internal filter member to be inserted into the prefilter cartridge as illustrated within FIG. 16;

FIG. 18 is a top perspective view similar to FIG. 16, showing, however, more details of the structure comprising the prefilter cartridge including the holes within the central outlet core tube of the prefilter cartridge;

FIG. 19 is a schematic cross-sectional view, similar to that of FIG. 8, illustrating, however, the fluid flow through the first embodiment modular multimedia fluid treatment system as disclosed within FIG. 4;

FIG. 20 is a top perspective view of the third chemical reduction or fluid treatment cartridge disposed within the first embodiment fluid treatment system and showing the carbon granule filter structure;

FIG. 21 is a schematic view, with some parts having been eliminated for clarity, showing the upper portion of the prefilter cartridge wherein a flow diverter has been optionally incorporated upon the upper structure of the prefilter cartridge for use, during the backwashing or reverse flushing of the filter media of the prefilter cartridge, along with a flow director incorporated within the conduit leading into the solenoid-controlled reverse flow valve connector; and

FIG. 22 is an exploded view of a two-cartridge modular multimedia fluid treatment system comprising, for example, a prefilter cartridge and a chemical reduction/fluid treatment cartridge.

### DETAILED DESCRIPTION OF THE ILLUSTRATED EMBODIMENTS

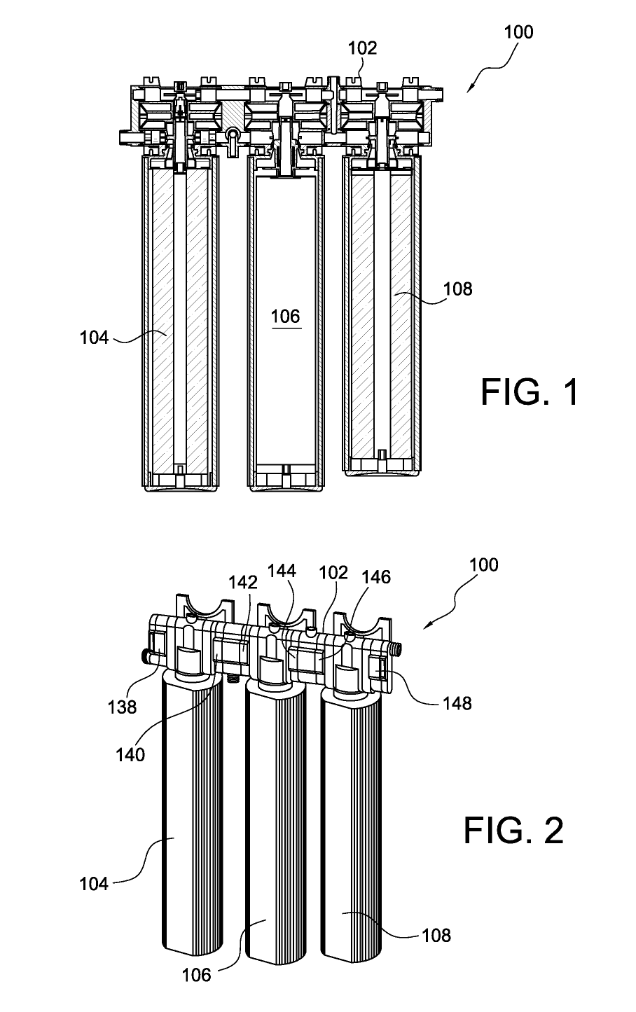

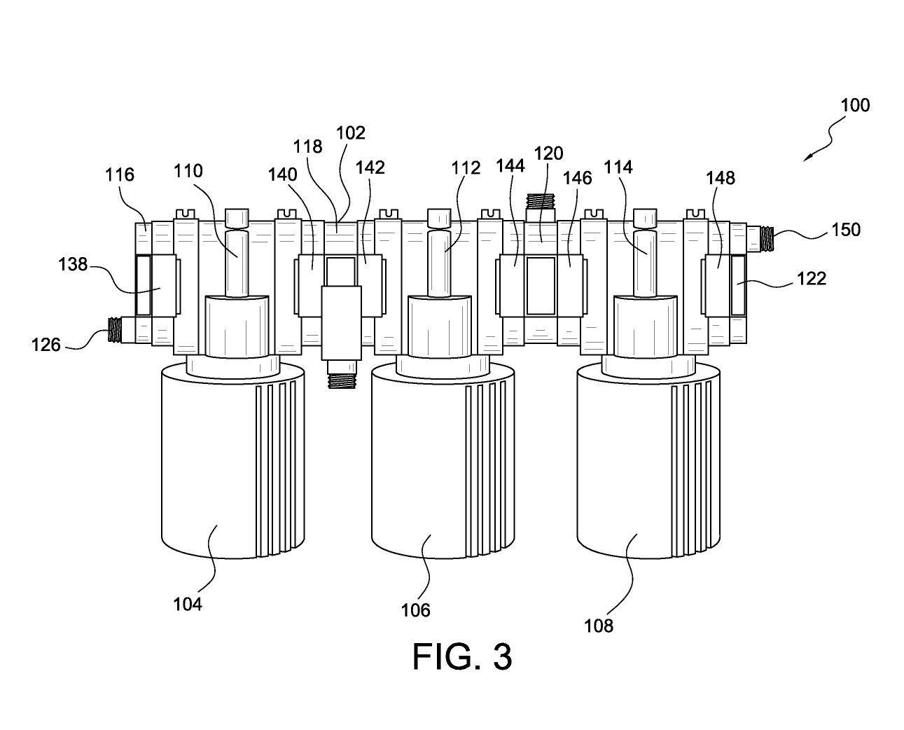

Referring now to the drawings, and more particularly to FIGS. 1-4 thereof, a first embodiment of a new and improved modular multimedia fluid treatment system is disclosed and is generally designated by the reference character 100. More particularly, it is seen that the first embodiment modular multimedia fluid treatment system 100 comprises a manifold structure 102 within which, as will become more apparent, the various fluid flow paths, from the fluid inlet to the fluid outlet, are defined. A plurality of modular fluid treatment cartridges comprising, for example, a prefilter cartridge 104, a fluid storage cartridge 106, and a chemical reduction/fluid treatment cartridge 108, are respectively mounted in a snap-fitted manner upon a plurality of head members 110,112,114 which are incorporated within and form integral components of the manifold structure 102. As may best be additionally seen from FIG. 3, the manifold structure 102 of the system 100 further comprises a first fluid input end connector 116 which is mounted upon, for example, the left end portion of the manifold 102, as viewed in FIG. 3, in a snap-fitted manner which will be discussed more fully hereinafter, so as to be fluidicially connected to a first side portion of the first head member 110. A first side portion of a flush valve assembly connector 118 is then mounted upon and fluidically connected to a second opposite side portion of the first head member 110 in a snap-fitted manner, while a second opposite side portion of the flush valve assembly connector 118 is mounted upon and fluidically connected to a first side portion of the second head member 112. In turn, a first side portion of a flow direction connector 120 is mounted upon and fluidicially connected to a second opposite side portion of the second head member 112, while a second side portion of the flow direction connector 120 is mounted upon and fluidically connected to a first side portion of the third head member 114. Lastly, a second fluid output end connector 122 is mounted upon and fluidically connected to a second opposite side portion of the third head member 114.

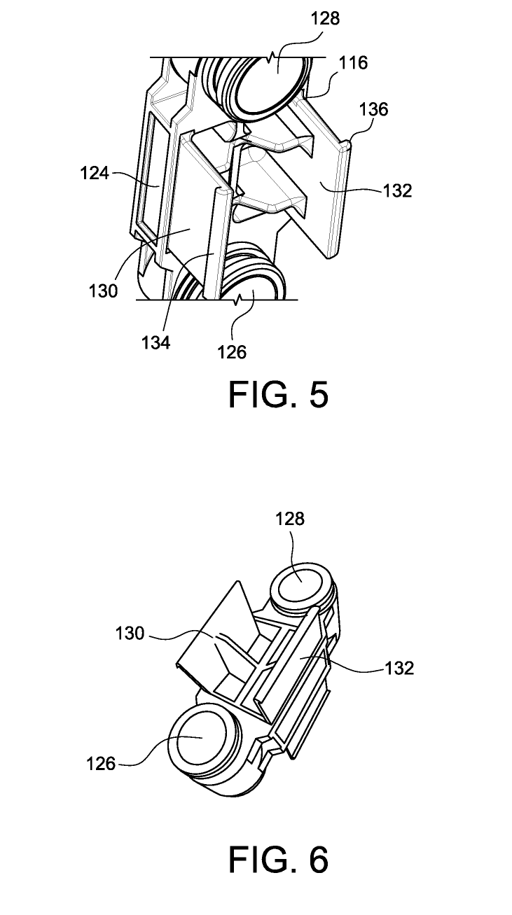

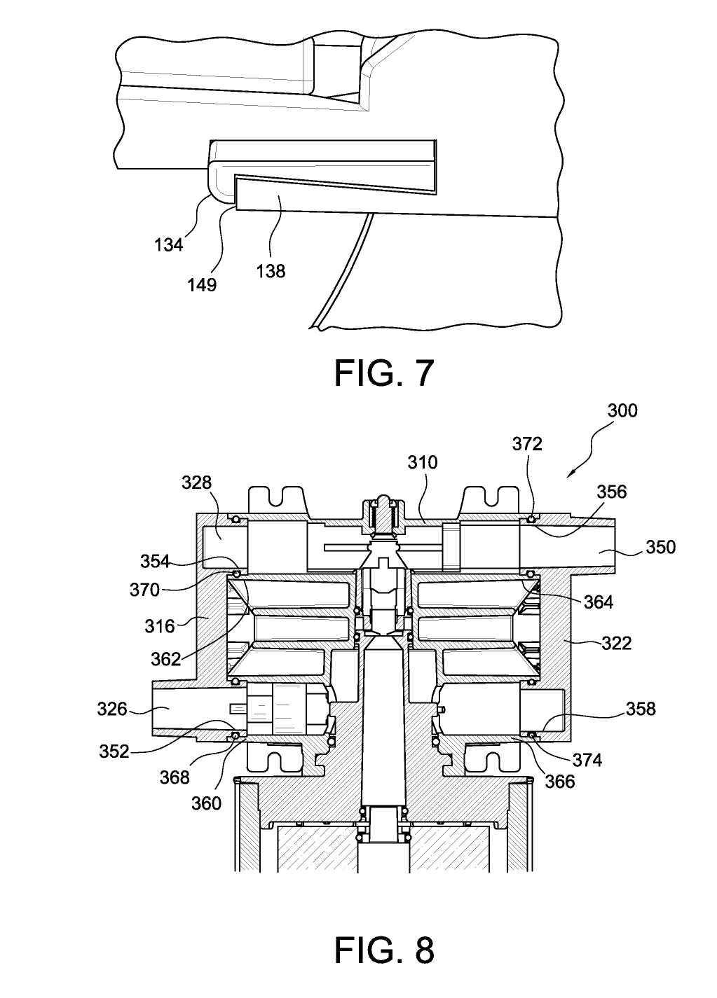

With additional reference now being made to FIGS. 5-8, the structures of the aforenoted head members 110,112,114 and the connectors 116, 118,120,122, for permitting the connectors 116,118,120,122 to be mounted upon and fluidically connected to the head members 110,112,114 in a snap-fitted manner, will now be described. More particularly, with reference first being made to FIG. 5, there is shown one of the first or second end connectors which can serve either as the first fluid input connector 116 or the second fluid output connector 122 as will be explained more fully hereinafter. For discussion purposes, it is assumed that the connector is the first fluid input connector 116. Accordingly, it is seen that the connector 116 comprises a molded structure which is provided with a central body portion 124, a lower flow-through fluid inlet conduit and port 126, and an upper closed-off or dead end portion 128. Located between the lower fluid inlet port 126 and the upper closed-off portion 128 are a pair of laterally spaced, horizontally oriented male connection members 130,132 which are integrally connected at first end portions thereof to the central body portion 124 while opposite end portions thereof extend away from the central body portion 124, in a parallel manner, and terminate in end latch members 134,136. The opposite side portions of each one of the head members 112,114,116 have female slot or socket portions 138, 140,142,144,146,148 which can best be seen, for example, within FIGS. 2 and 3, within which the male connection members 130,132 are adapted to be inserted. When the male connection members 130,132 have been fully inserted into the female slot or socket portions 138,140,142,144,146,148, the male end latch members 134,136 of each connector 116 will latch over the open end edge portions 149 of the female slot or socket portions 138,140,142,144,146,148 thereby securely latching the male connection members 130,132 within the particular female slot or socket portions of the particular head member 110,112,114. This locking or latching structure can best be seen in FIG. 7.

As can best be appreciated from FIG. 8, wherein a second embodiment of a modular multimedia fluid treatment system 300 is disclosed such that further structural details of the first and second fluid inlet and fluid outlet connectors 316 and 322 can be seen, it being appreciated that connectors 316,322 are identical to fluid inlet and fluid outlet connectors 116,122 except that they have been designated by means of reference characters within the 300 series, as will other cornponents of the system 300 relative to corresponding components of the system 100. It is firstly noted that the fluid inlet and fluid outlet connectors 316,322 are also identical to each other in that either one can be mounted upon the fluid inlet end of the system 300 while the other one is mounted upon the outlet end of the system 300. This is able to be achieved in view of the fact that the fluid inlet and fluid outlet connectors 316,322 are reversible in that, for example, the fluid inlet conduit and port 326 is located at the lower left portion of the fluid inlet connector 316, however, if the fluid inlet connector 316 is effectively reversed or rotated 180°, it is seen that the fluid inlet conduit or port 326 has now effectively become the fluid outlet conduit or port 350 which is located at the upper right portion of the fluid outlet connector 322. Continuing further, and with reference still being made to FIG. 8, it is also seen that in order to properly fluidically mate, for example, each one of the fluid inlet or fluid outlet end connectors 316,322 with a particular head member 310 of the system 300, the fluid inlet conduit and port portion 326 as well as the closed-off or dead-end portion 328 of the fluid inlet connector 316 are provided with reduced external diameter male portions 352,354,356,358 for insertion with reduced internal diameter female portions 360,362,364,366 formed within the opposite side portiuons of the head member 310. O-ring seal members 368,370,372,374 are preferably provided along the annular interfaces between the male portions 352,354, 356,358 and the female portions 360,362,364,366 so as to prevent any fluid leakage.

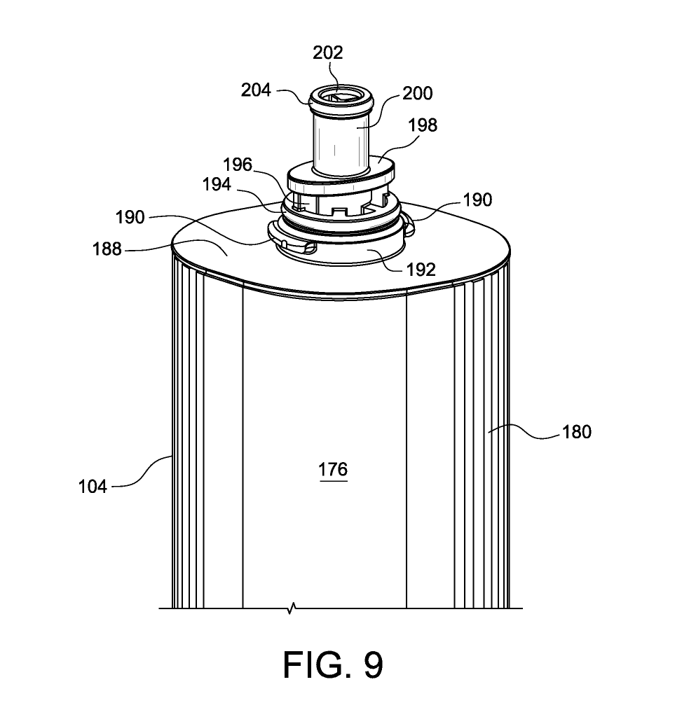

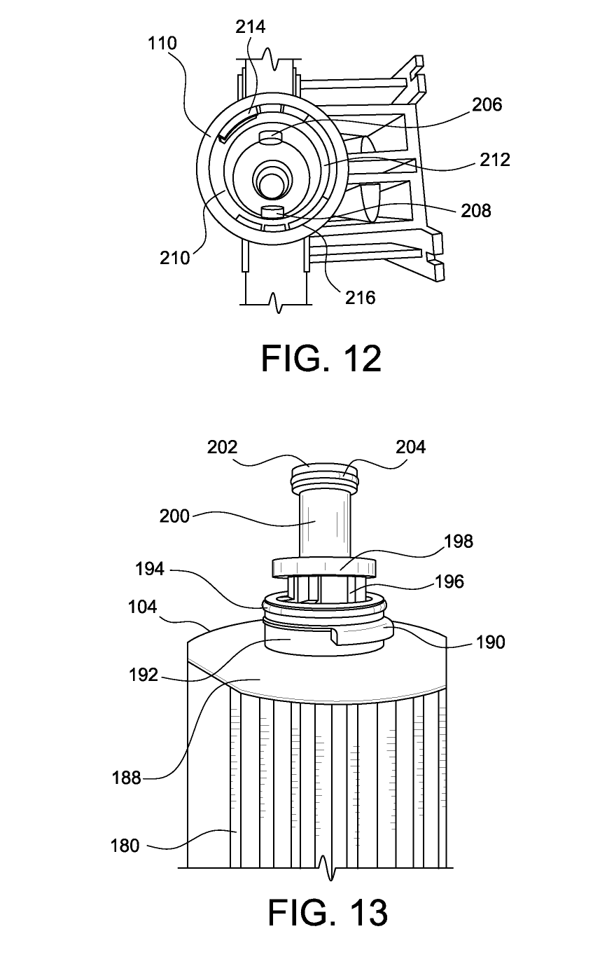

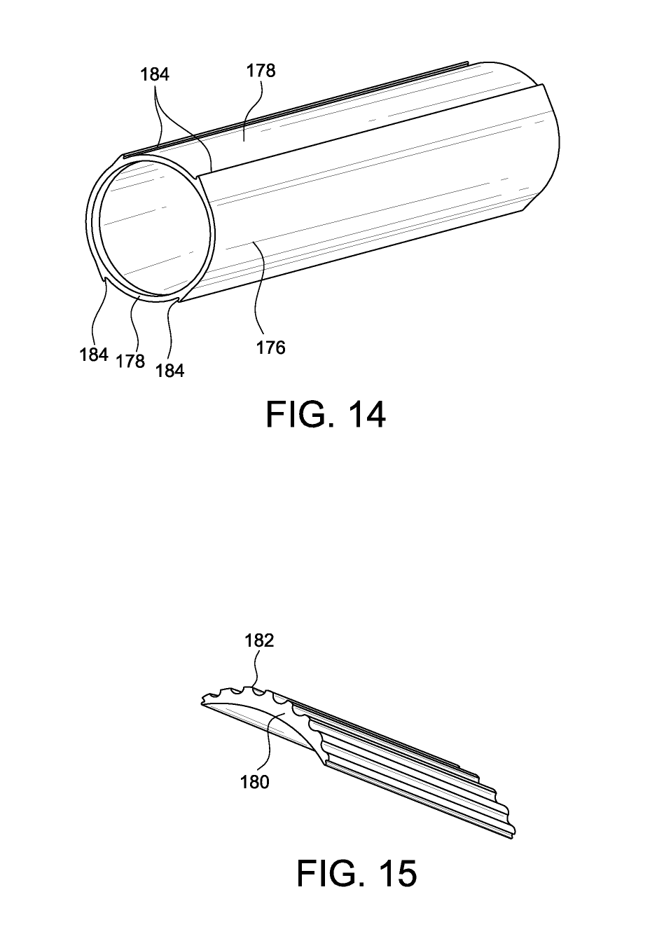

With reference now being made to FIGS. 9-15, the upper end portion of one of the prefilter or chemical reduction/fluid treatment cartridges 104, 108 is disclosed in FIG. 9. For the purpose of the description of the cartridge structure illustrated within FIG. 9, the illustrated cartridge will be referred to as the prefilter cartridge 104, it of course being understood that from an external view-point, the prefilter and chemical reduction/fluid treatment cartridges 104,108 are identical. More particularly, it is seen that the prefilter cartridge 104 is seen to comprise an external housing 176 which, as can best be seen in FIG. 14, is provided with a pair of diametrically opposed, longitudinally extending cut-out portions 178 within which a pair of diametrically opposed inserts 180, as illustrated within FIG. 15, are adapted to be disposed. Each one of the inserts 180 has a plurality of longitudinally extending ribs 182 formed upon the external surface portions of the inserts 180 so as to provide service or maintenance personnel with enhanced tactile surface regions which are easier to handle than smooth external surface portions. In this manner, the handling of the cartridges are rendered safer even when the external surface portions of the cartridges should become wet. In order to mount the inserts 180 into the external cut-out portions 178 of the cartridges, laterally spaced side edge regions of each one of the cut-out portions 176 are provided with longitudinally extending female slots or tracks 184 within which laterally spaced male edge portions 186 are adapted to be received in a manner similar to the mating pins and tails of a dovetail joint.

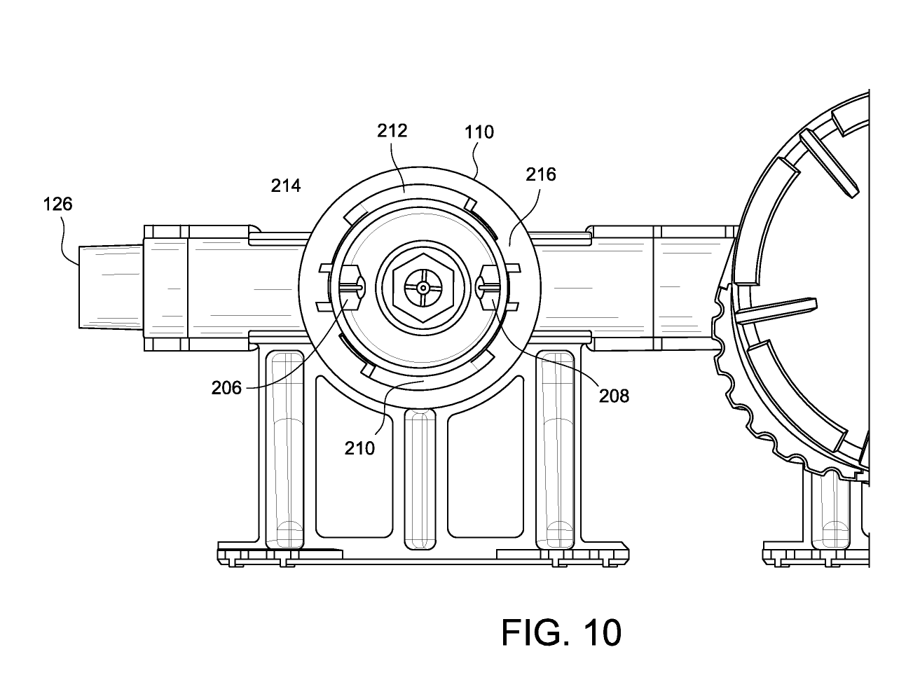

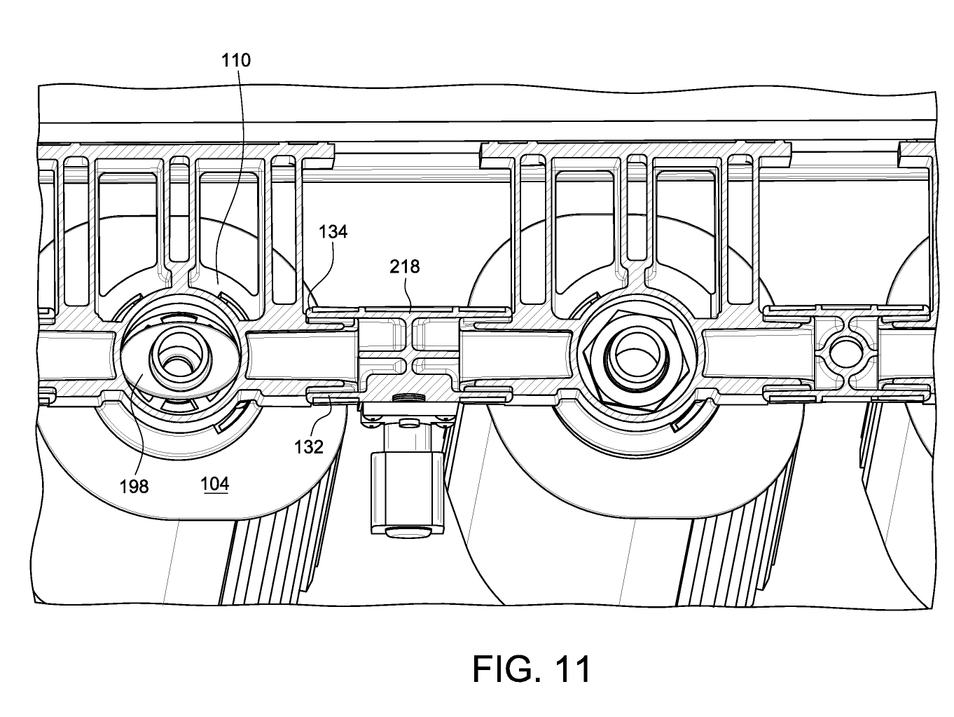

Reverting back to FIG. 9, and with additional reference being made to FIG. 13, and continuing with the description of the prefilter cartridge 104, it is to be appreciated that the opposite end portions of the cartridge 104 are provided with end cap members 188, although only the upper or outlet end cap 188 is visible within FIG. 9, and a pair of diametrically opposed quarter-turn locking lugs 190 are provided upon a vertically stepped end structure 192. A first O-ring sealing member 194 is disposed around a section of the stepped structure 192 that is located vertically above the locking lugs 190, and a fluid inlet port 196 is defined within a sidewall portion of the stepped structure 192 at a location that is above the first O-ring sealing member 194. An elliptical cam member 198 is fixedly secured upon an upstanding outlet conduit 200, a fluid outlet port 202 is defined within the distal open end of the outlet conduit 200, and a second O-ring sealing member 204 is disposed around the external surface portion of the fluid outlet conduit 200 at a position immediate adjacent to the fluid outlet port 202. As can best be seen in FIGS. 10-12, which discloses an interior view of, for example, the head member 110, the head member 110 has incorporated therein a pair of diametrically opposed spring-biased check valves 206,208. The check valves 206,208 are illustrated at their CLOSED positions. In addition, the head member 110 also has incorporated therein a pair of diametrically opposed quarter-turn insert spaces 210,212 and a pair of diametrically opposed overlying locking ledges 214,216. Accordingly, it can be appreciated that when, for example, the cartridge 104 is to be fixedly mounted upon the head member 110, the upper end portion of the cartridge 104, as illustrated within FIG. 9, is inserted into the head member 110, as illustrated within FIG. 10, the pair of diametrically opposed locking lugs 190 will be inserted into the pair of diametrically opposed quarter-turn insert spaces 210,212 of the head member 110, and the cartridge 104 will then be angularly rotated 90° so as to effectively move the diametrically opposed locking lugs 190 from their respective positions within the quarter-turn insert spaces 210,212 to locations at which the locking lugs 190 are now respectively disposed above the pair of diametrically opposed locking ledges 214,216, thereby fixedly securing the cartridge 104 upon the head member 110. In addition to the aforenoted locking of the cartridge 104 upon the head member 110, it can also be appreciated, as can best be understood from FIG. 11, that when the cartridge 104 is first inserted into the head, the minor axis of the elliptical cam member 198 will be aligned with the locus extending between the pair of diametrically opposed spring-biased check valves 206,208 such that the spring-biased check valves 206,208 are initially disposed at their CLOSED positions. However, as the cartridge 104 is rotated 90° so as to achieve the afore-noted locked mounting of the cartridge 104 upon the head member 110, the elliptical cam member 198, disposed upon the upper structure of the cartridge 104, will likewise be rotated 90° such that the major axis of the elliptical cam member 198 will now be aligned with the locus extending between the pair of diametrically opposed spring-biased check valves 206,208. Accordingly, the pair of diametrically opposed spring-biased check valves 206,208 will be forced to their OPEN positions whereby fluid flow into and out from the cartridge 104 can be achieved.

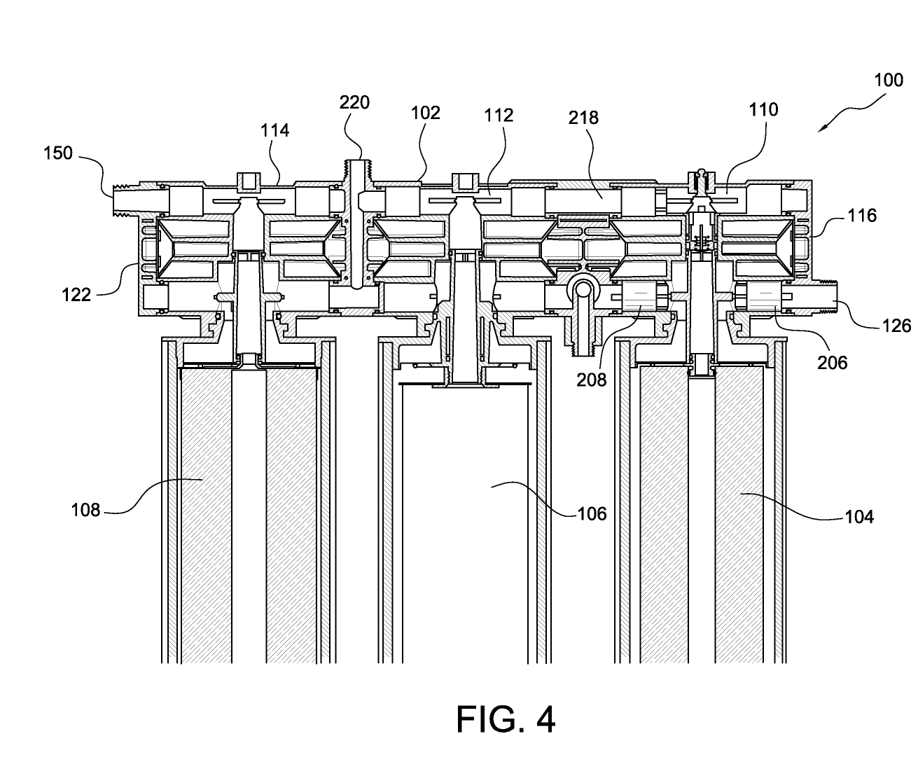

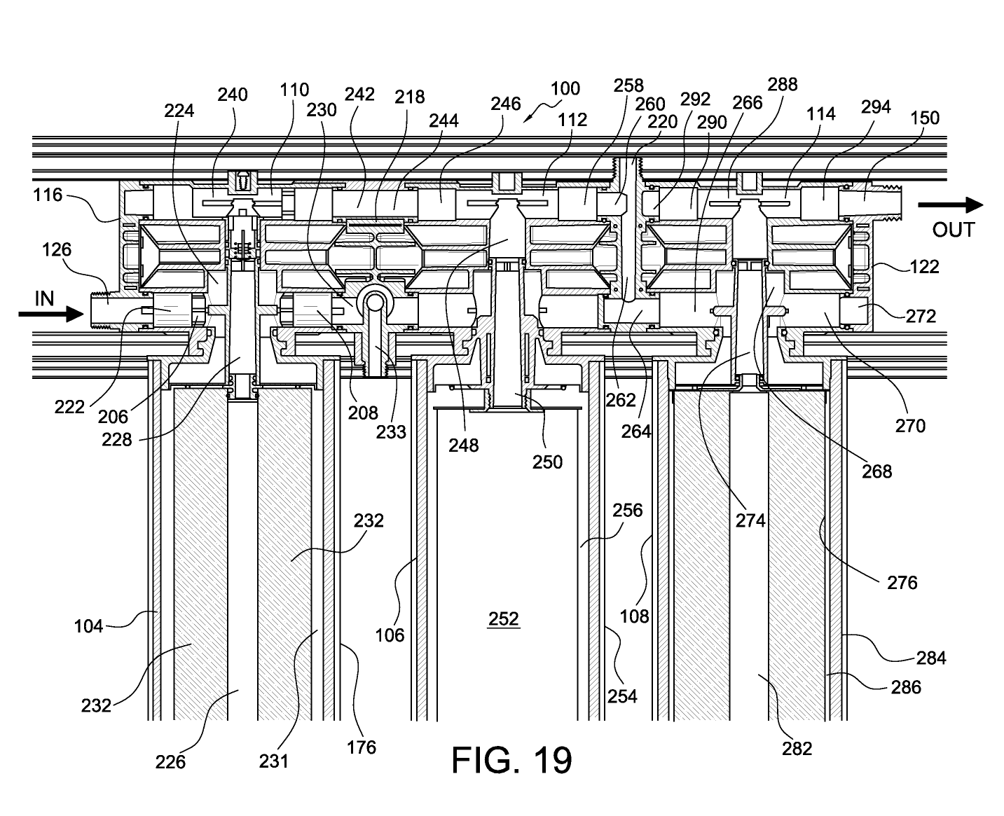

Reverting back now to FIG. 4, and with additional reference being made to FIG. 19, other components of the three-cartridge modular multimedia fluid treatment system 100 will now be discussed. In addition to the first and second end connectors 116,122, and the first, second, and third head members 110,112, 114 comprising in combination the manifold 102, the manifold 102 also has incorporated therewithin a first intermediate backwash or reverse flow solenoid-controlled valve connector 218 which is interposed between the first head member 110 and the second head member 112. Similarly, a second intermediate flow directional connector 220 is interposed between the second head member 112 and the third head member 114 so as to effectively alter the route of the permeate fluid being discharged from the second fluid storage cartridge 106 and being conducted into the third chemical reduction/fluid treatment cartridge 108. These fluid flow paths through the first, second, and third cartridges 104,106,108, the first, second, and third head members 110,112,114, as well as through the manifold 102 and the end and intermediate connectors 116,122,218,220 will now be described for a better understanding of the overall operation of the modular multimedia fluid treatment system 100. More particularly, with reference best being made to FIG. 19, the fluid to be treated is conducted into the first inlet conduit and port 126 of the first end connector 116 wherein it initially flows in a horizontal direction into a first horizontally oriented conduit section 222 of a +-shaped conduit 224 which is fixedly mounted within the first head member 110 and which is fluidically connected to the first inlet conduit 126 of the first end connector 116. The first prefilter cartridge 104 is of course lockingly mounted upon the first head member 110, and as such, the first prefilter cartridge 104 contains a vertically oriented, coaxially located permeate discharge tube 226 which is mated with a second vertically oriented permeate discharge tube 228 which passes upwardly through the first head member 110. The incoming fluid flows through the +-shaped conduit 224 wherein a second conduit 230, disposed diametrically opposite the first inlet conduit 126, is located within and forms part of the solenoid-controlled valve connector 218, however, since the solenoid-controlled valve connector 218 is, at this time, closed, the route of the incoming fluid is effectively dead-ended. The incoming fluid therefore continues to flow through the +-shaped conduit 224, around the second vertically oriented permeate discharge tube 228, and enters the top of the first prefilter cartridge 104.

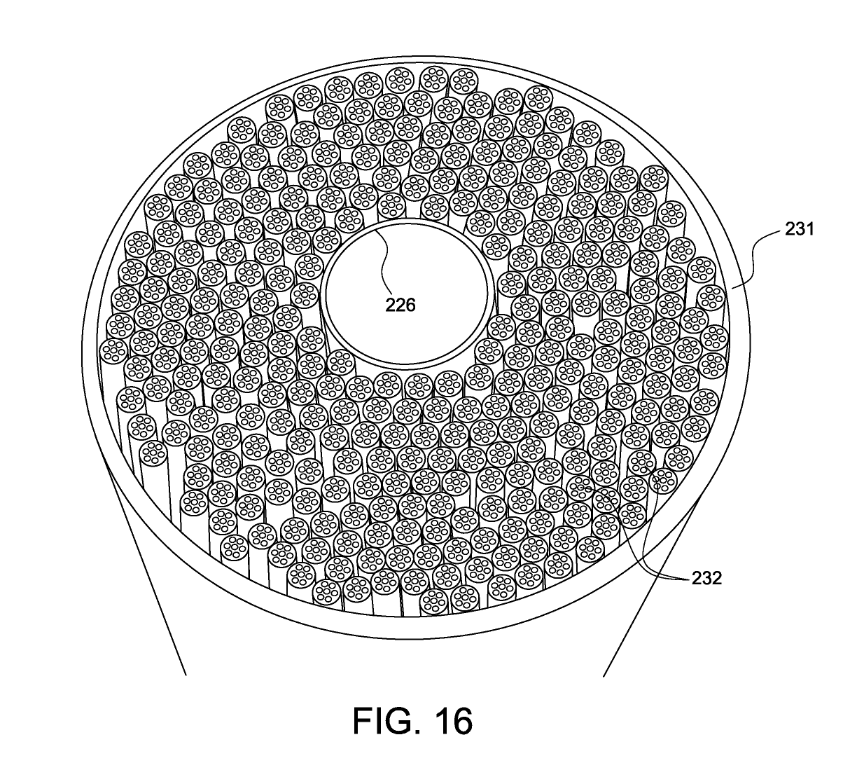

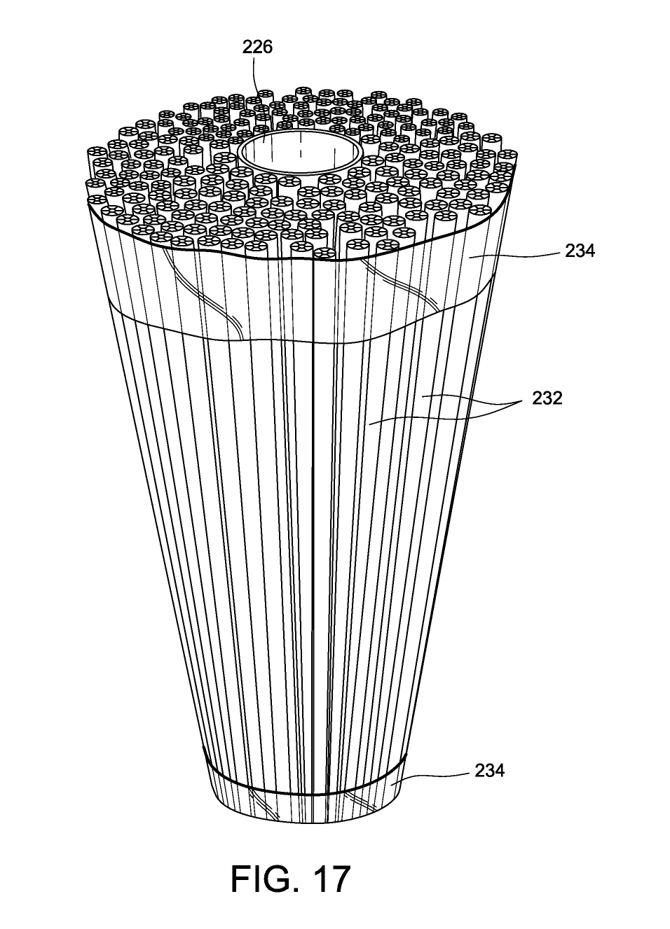

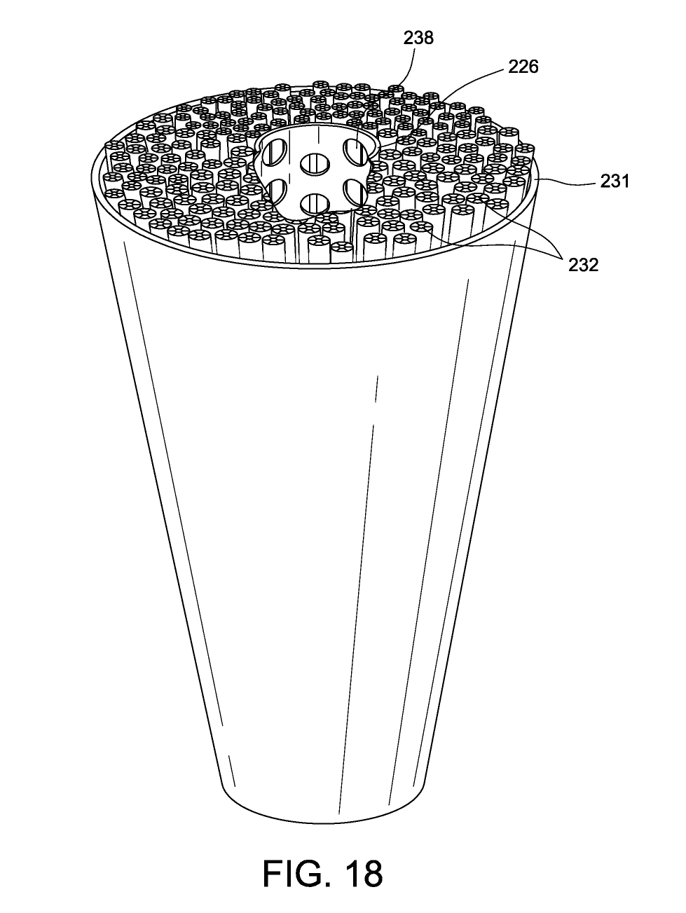

Before continuing further, reference is hereby made to FIGS. 16-18 wherein the structure of the prefilter cartridge 104 is disclosed in more detail. More particularly, it is seen, from FIGS. 16 and 18, that the prefilter cartridge 104 comprises an external casing 231 which, itself, is adapted to be disposed within the external housing 176 as disclosed within FIG. 14. The casing 231 is impervious and encloses a multiplicity of vertically oriented, hexagonally configured filter members 232, each one of which can be seen to comprise seven filter conduits with six of the conduits disposed at each corner of each hexagonally configured filter member and surrounding a central filter conduit. As can best be seen in FIG. 17, the upper and lower ends of the filter members 232 are bonded together, both internally and externally, by means of a suitable epoxy or similar binding material or wrapping 234 so as to effectively form a filter module, and the epoxy or similar binding material or wrapping 234 is also fixedly secured in a sealed manner to internal peripheral wall portions of the casing 231. In this manner, it can be appreciated that when the incoming fluid enters the top of the external housing 176, it can only enter the open upper ends of each one of the seven filter conduits formed within each one of the filter members 232, or alternatively, the incoming can traverse across the upper end portion of the filter module, flow downwardly within an annular chamber 236 defined between the external casing 231 and the external housing 176, as can be seen in FIG. 19, and upwardly through the open lower ends of each one of the seven filter conduits formed within each one of the filter members 232. Once the incoming fluid has passed through the multiplicity of filter members 232, the fluid permeate can enter the vertically oriented, coaxially located permeate discharge tube 226 as a result of a multiplicity of holes or apertures 238 formed within side wall portions of the permeate discharge tube 226, as can best be seen in FIG. 18, all along its length. The lower end portion of the permeate discharge tube 226 is capped or otherwise closed off so as to prevent unfiltered fluid from entering the permeate discharge tube 226 whereby only filtered fluid, having passed through the filter members 232, is permitted to enter permeate discharge tube 226.

Reverting back to FIG. 19, once the fluid permeate has entered the permeate discharge tube 226, the fluid continues upwardly through the second permeate discharge tube 228 and flows into a first T-shaped connector conduit 240 disposed within the head member 110. The left end portion of the T-shaped connector conduit 240 effectively dead ends at the closed-off port 128 of the first end connector 116, however, the right end portion of the T-shaped connector conduit 240 is fluidically connected to a first left side fluid conduit 242 disposed within the first intermediate backwash or reverse flow solenoid-controlled valve connector 218. The left side fluid conduit 242 is fluidically connected to a right side fluid conduit 244 disposed within the first intermediate backwash or reverse flow solenoid-controlled valve connector 218, and the right side fluid conduit 244 is, in turn, fluidically connected to a left side fluid conduit 246 formed within a second T-shaped connector conduit 248 which is disposed within the second head member 112 and which is similar to the first T-shaped connector conduit 240. It is further seen that the vertically oriented portion of the second T-shaped connector conduit 248 is fluidically connected to a second permeate flow conduit 250 which is similar to the first permeate discharge tube 228. The second permeate flow conduit 250 is connected to the upper end portion of a fluid bladder 252, which is disposed within the fluid storage cartridge 106, and it is seen that the external surface portion of the fluid bladder 252 is actually spaced from the internal peripheral surface portion of the fluid storage cartridge housing 254. The annular space 256 contains pressurized air so as to normally compress the fluid bladder 252, however, as fluid is conducted into the bladder 252, the bladder 252 expands and serves as a fluid storage bladder. When the pressure within the bladder 252 is equal to the pressure within the annular chamber 256, the bladder 252 ceases to expand and the fluid permeate continues on with its flow through a right side fluid conduit 258 formed within the T-shaped connector conduit 248.

The fluid conduit 258 is fluidically connected to a fluid inlet conduit 260 which is located within the upper left region of the second intermediate flow directional connector 220 which is seen to have a substantially I-shaped cross-sectional configuration. The fluid inlet conduit 260 is, in turn, fluidically connected to an upper end portion of a vertically oriented fluid conduit 262 which extends along the vertical axis of the flow directional connector 220 whereby the fluid then flows into a horizontally oriented fluid outlet conduit 264 formed within a lower portion of the flow directional connector 220. The fluid outlet conduit 264, in turn, is fluidically connected to a horizontally oriented fluid inlet conduit 266 formed within a lower portion of the head member 114, and in this manner, it can be appreciated that the fluid flow has effectively been transferred or re-routed from an upper region of head member 112 to a lower region of head member 114. Fluid inlet conduit 266 forms the left side portion of a second +-shaped fluid conduit 268, disposed within the head member 114, which is similar to the +-shaped fluid conduit 224 disposed within the head member 110, and it is seen that a second fluid conduit 270, disposed diametrically opposite the first inlet conduit 266, is located within and forms part of the head member 114. Fluid conduit 270, however, is fluidically connected to a closed or dead-end port 272 defined within the second end connector 122, and therefore that portion of the fluid flow does not flow anywhere. The incoming fluid therefore continues to flow through the second +-shaped conduit 268, around a third vertically oriented fluid discharge tube 274, and enters the top of the third chemical reduction/fluid treatment cartridge 108.

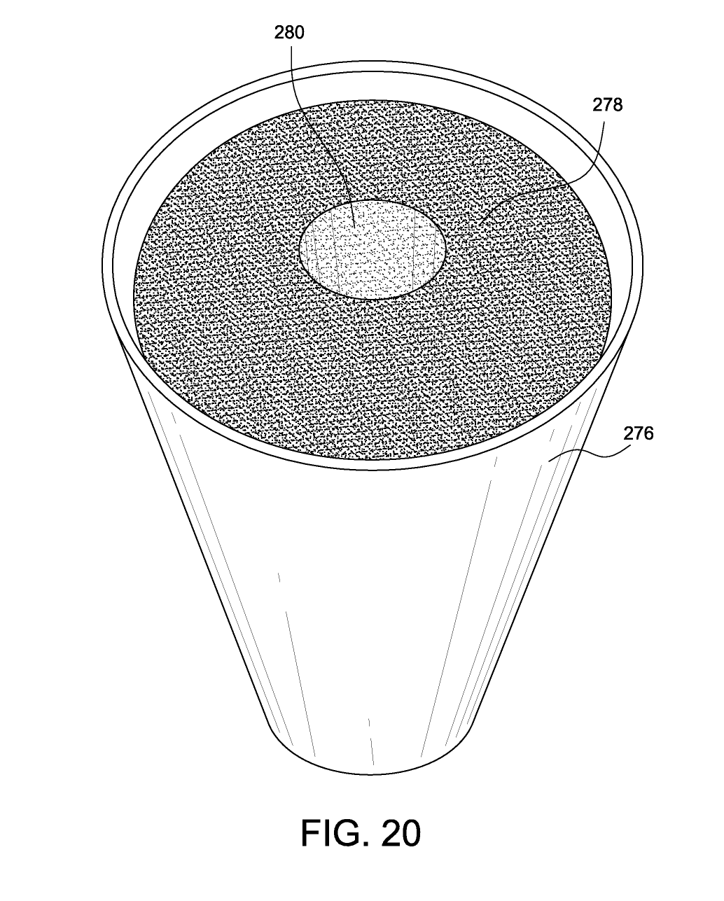

Before continuing with the fluid flow through the modular multimedia fluid treatment system 100, reference is made to FIG. 20 which discloses the chemical reduction/fluid treatment cartridge module which effectively comprises a carbon filtration system. More particularly, as can readily be appreciated from FIG. 20, the carbon filtration system comprises an outer porous container or casing 276 within which a block of molded carbon granules 278 is located. A central bore 280 is formed within the central or axial portion of the carbon block 278, and preferably a lower filtration fluid discharge tube 282, similar to the fluid permeate discharge tube 226, is inserted within the bore 280 and fluidically connected to the upper filtration fluid discharge tube 274 as seen in FIG. 19. As was the case with the casing 231 with respect to the housing 176 of the prefilter cartridge 104, the container or casing 276 is spaced radially inwardly from the inner peripheral wall portion of an external housing 284 of the chemical reduction/fluid treatment cartridge 108 so as to define an annular space 286 therebetween.

Accordingly, the fluid permeate flowing into the top of the third chemical reduction/fluid treatment cartridge 108 flows onto the upper surface portion of the carbon block 278, may overflow the carbon block 278 and flow downwardly within the annular space 286, and may therefore flow both axially downwardly through the carbon block 278 as well as radially inwardly through the carbon block 278 after passing through the porous casing or container 276. Holes, not shown, may be provided within the lower filtration fluid discharge tube 282, in a manner similar to the holes 238 provided within the fluid permeate discharge tube 226, whereby the filtration fluid will pass upwardly through the lower filtration fluid discharge tube 282, the upper filtration flu-id discharge tube 274, and into a third T-shaped fluid conduit 288 which is disposed within head member 114 and which is similar to the first and second T-shaped fluid conduits 240,248. The upper left portion of the third T-shaped fluid conduit 288 has a fluid conduit 290 defined therein which is fluidically connected to a closed-off or dead-end port 292 defined within the upper right portion of the I-shaped flow directional connector 220, while the upper right portion of the third T-shaped fluid conduit 288 has a fluid conduit 294 defined therein which is fluidically connected to the fluid outlet conduit 150 defined within the end connector 122.

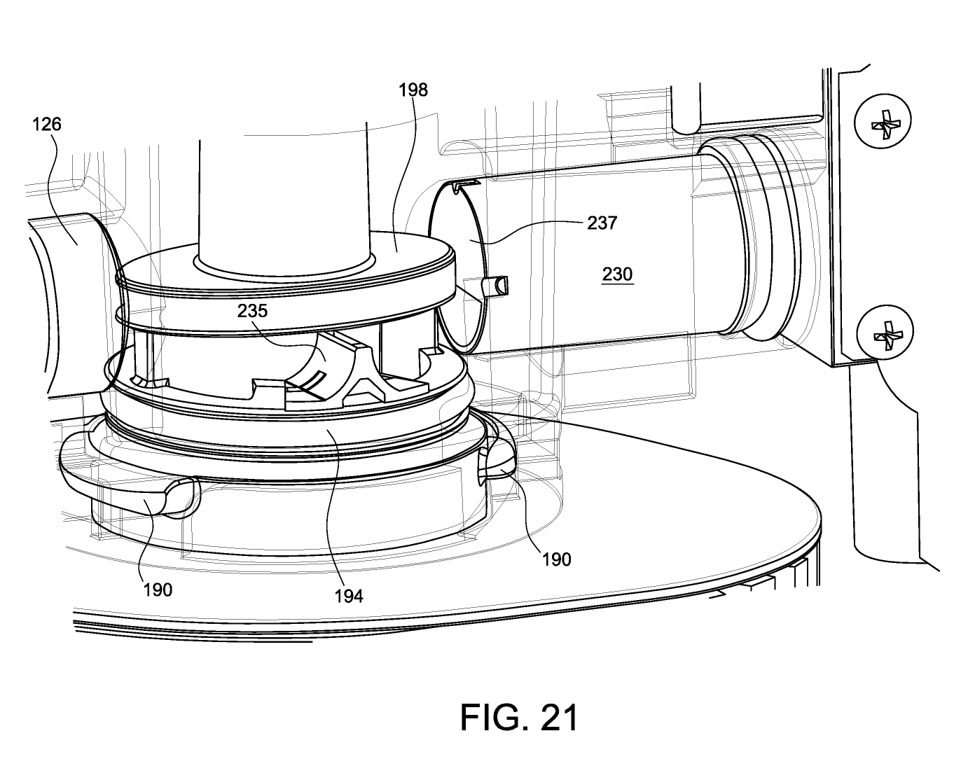

Accordingly, when the fluid outlet conduit 150 is open, and the solenoid controlled reverse flow valve connector 218 is closed, incoming fluid is converted to fluid permeate within the first prefilter cartridge 104, a predetermined amount of the fluid permeate is stored within the second fluid storage cartridge 106, and filtration fluid is conducted out from the third chemical reduction/fluid treatment cartridge 108 as has just been described. When backwashing or reverse flushing of the filter elements 232 disposed within the first prefilter cartridge 104 is to be achieved, the solenoid-controlled valve, not shown but disposed within the solenoid-controlled reverse flow valve connector 218, is moved to its OPEN position whereby due to the release of pressure within the system, the air pressure within the housing 254 of the second fluid storage cartridge 106 will effectively force the fluid permeate contained within the bladder 252 to flow backwardly in a reverse direction, out from the bladder 252, through second permeate fluid flow conduit 250, and into fluid permeate discharge tubes 228,226 such that the fluid permeate will flow radially outwardly through the first lower fluid permeate discharge tube 226 so as to cause any sediment or particles entrapped within the filter elements 232 to be flushed outwardly therefrom back into the original inlet fluid stream whereby such filter debris will be eliminated from the system through an exhaust or waste port/conduit 233 defined within the solenoid-controlled reverse valve connector 218. At the same time, incoming fluid will also go directly from inlet fluid conduit 126 since such is now fluidically connected to the exhaust or waste port/conduit 233 through means of the OPEN solenoid-controlled valve, not shown, of the solenoid-controlled reverse valve connector 218. In conjunction with the backwashing or reverse flushing of the filter elements 232, reference is also made to FIG. 21 where there is shown a flow diverter 235 which has a substantially triangular configuration or a configuration simulating a pair of back-to-back ski jumps. Accordingly when fluid to be treated comes into the system from fluid inlet conduit 126, as is shown in FIG. 19, to be mixed with the backwashed or reverse flow of fluid permeate from the bladder cartridge 106 flowing through the upper fluid permeate discharge tube 228, the lower fluid permeate discharge tube 226, and the filter members 232 so as to achieve backwashing or reverse flow of the fluid permeate through the filter members 232 in order to rid the same of any accumulated debris, the flow diverter 235 will effectively cause a low pressure-high velocity area to develop within such fluid flow region since a venturi is effectively developed between the flow diverter 235 and the elliptical cam member 198. In addition, it is also seen that the check valve 208, as illustrated within FIG. 19, can be optionally eliminated from the prefilter cartridge 104 in view of the fact that only the incoming fluid through inlet conduit 126 needs to be CLOSED when the prefilter cartridge 104 is disconnected from the first head member 110. Accordingly, the second fluid conduit 230, within the solenoid-controlled reverse valve connector 218, can be extended so as to fluidically mate with the rightwardly extending fluid discharge branch of the +-shaped conduit 224 within the first head member, and it is additionally seen from FIG. 21 that the open end portion of the second fluid conduit 230 is provided with a flow director 237 which is embodied as an end cap which covers the upper half portion of the open end portion of the second fluid conduit 230. This likewise provides an additional venturi within the system whereby the low pressure, high velocity fluid flow through the second fluid conduit 230 helps to enhance the outflow of the fluid and the discharge of the accumulated debris from the filter members 232 during such backwashing or reverse flushing of the prefilter members 232.

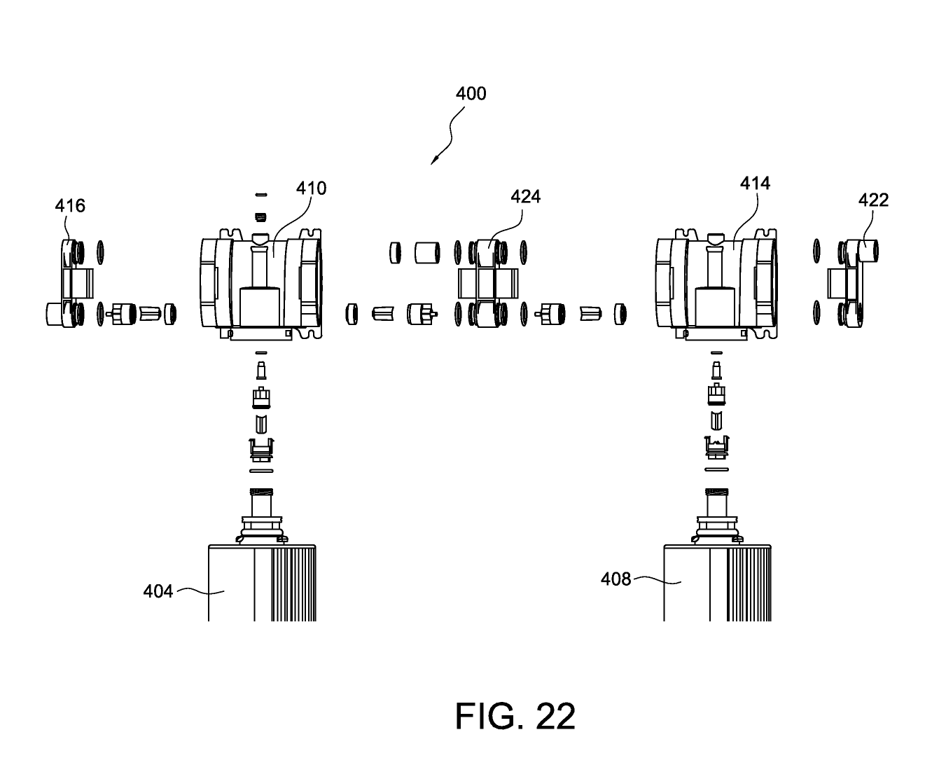

With reference lastly being made to FIG. 22, a third embodiment of a new and improved modular multimedia fluid treatment system which is generally indicated by the reference character 400. Component parts of the third embodiment system 400 which correspond to component parts of the first and second embodiment systems 100,300 will be designated by corresponding reference characters, except that they will be within the 400 series. A detailed description of the third embodiment system 400 has been omitted herefrom for brevity reasons, however, it is to be noted that the fluid treatment system 400 comprises only a pair of cartridges comprising, for example, the prefilter cartridge 404 and the chemical reduction media cartridge 408, the fluid storage cartridge having effectively been eliminated because in lieu of needing to backwash or reverse flush the prefilter cartridge 404, one may simply choose to replace the prefilter cartridge 404 at a time when its known service life limit is approaching. Still yet further, while the various cartridges can effectively be connected in series with respect to each other, wherein, for example, the output from one cartridge is routed so as to flow into the next cartridge, one or more cartridges may be arranged in parallel with respect to each other wherein fluid, to be treated, is simultaneously conducted through the one or more cartridges and then their combined output is, for example, combined so as to flow into a final treatment cartridge. These various embodiments add variability and versatility to the disclosed modular multimedia fluid treatment system.

Obviously, many variations and modifications of the present invention are possible in light of the above teachings. It is therefore to be understood that within the scope of the appended claims, the present invention may be practiced otherwise than as specifically described herein.

### NUMBER KEY GUIDE

100—modular multimedia fluid treatmemt system
102—manifold structure
104—prefilter cartridge
106—fluid storage cartridge
108—chemical reduction/fluid treatment cartridge
110—first head member for mounting 104
112—second head member for mounting 106
114—third head member for mounting 108
116—first fluid input end connector
118—flush valve assembly connector
120—flow direction connector
122—second fluid output connector
124—body of end connector 116
126—fluid inlet conduit and port of 116
128—closed-off port of 116
130—male connection member of 116
132—male connection member of 116
134—latch member of 130
136—latch member of 132
138—female slot/socket of one of the heads 110,112,114
140—female slot/socket of one of the heads 110,112,114
142—female slot/socket of one of the heads 110,112,114
144—female slot/socket of one of the heads 110,112,114
146—female slot/socket of one of the heads 110,112,114
148—female slot/socket of one of the heads 110,112,114
149—edge of pocket in head member for latching with 134
150—fluid outlet conduit and port of 122
176—external housing of cartridge 104
178—cut-out region of 176
180—insert for insertion within 178
182—ribs of insert 180
184—laterally spaced tracks or slots of 178
186—laterally spaced edge portions of 180 for insertion within 184
188—outlet end cap of 104
190—locking lugs on 104
192—stepped structure on upper end of 104
194—first O-ring sealing member
196—fluid inlet port in 104
198—elliptical cam member of 104
200—fluid outlet conduit
202—fluid out port
204—second O-ring sealing member
206—check valve of 110
208—check valve of 110
210—insertion slot in 110 for one of the locking lugs 190
212—insertion slot in 110 for one of the locking lugs 190
214—locking ledge of 110
216—locking ledge of 110
218—first intermediate solenoid-controlled reverse flow valve connector
220—second intermediate flow directional connector
222—first horizontal conduit of 224
224—+ shaped conduit within first head member 110
226—lower permeate discharge tube of first cartridge 104
228—upper permeate discharge tube of first head member 110
230—second conduit within solenoid connector 218
231—casing of cartridge 104
232—filter members of 104
233—waste port for backwashing/reverse flushing
234—epoxy wrapping of 232
235—flow diverter
236—annular chamber between 230 and 176
237—flow director
238—holes in 226
240—T-shaped connector conduit within head 110
242—left side fluid conduit within solenoid valve connector 218
244—right side fluid conduit within solenoid valve connector 218
246—left side fluid conduit formed within second T-shaped conduit 248
248—second T-shaped conduit within solenoid valve connector 218
250—second permeate flow conduit within fluid storage cartridge
252—fluid bladder within fluid storage cartridge 106
254—fluid storage cartridge housing
256—annular space between bladder 252 and housing 254
258—right side fluid conduit in 248
260—fluid inlet conduit in 220
262—vertically oriented fluid conduit in 220
264—fluid outlet conduit in 220
266—fluid inlet conduit in 114
268—second +-shaped fluid conduit
270—second fluid conduit
272—closed or dead-end port defined within the second end connector 122
274—third vertically oriented fluid discharge tube
276—outer porous container or casing for carbon block 278
278—carbon block
280—central bore of carbon block 278
282—lower filtration fluid discharge tube within carbon block 278
284—external housing of cartridge 108
286—annular space between 276 and 284
288—third T-shaped fluid conduit in 114
290—upper left fluid conduit of 288
292—closed-off or dead-end port defined within upper right portion of 220
294—upper right fluid portion of fluid conduit 288
300—second embodiment fluid treatment system
316—first fluid input end connector of 300
322—second fluid output end connector of 300
350—fluid outlet conduit/port of 300
352—reduced external diameter male portion of connector of 300
354—reduced external diameter male portion of connector of 300
356—reduced external diameter male portion of connector of 300
358—reduced external diameter male portion of connector of 300
360—reduced internal diameter female portion of connector 300
362—reduced internal diameter female portion of connector 300
364—reduced internal diameter female portion of connector 300
366—reduced internal diameter female portion of connector 300
368—O-ring seal member of connector 300
370—O-ring seal member of connector 300
372—O-ring seal member of connector 300
374—O-ring seal member of connector 300
400—third embodiment modular multimedia fluid treatment system
404—prefilter cartridge
408—chemical reduction media cartridge
410—first head member
414—second head member
416—first fluid inlet connector
422—second fluid outlet connector
424—intermediate fluid connector

1. A modular multimedia fluid treatment system, comprising:
at least one head member;
at least one fluid treatment cartridge mounted upon said head member;
a fluid inlet fluidically connected to said at least one head member for introducing a fluid, to be treated, into said at least one head member;
a first fluid conduit defined within said at least one head member for conducting the fluid, to be treated, from said fluid inlet into said at least one fluid treatment cartridge;
a second fluid conduit defined within said at least one head member for conducting treated fluid out from said at least one fluid treatment cartridge and into said at least one head member;
a fluid outlet fluidically connected to said at least one head member for conducting treated fluid out from said at least one head member; and
cooperating quarter-turn locking members defined upon both said at least one head member and said at least one fluid treatment cartridge so as to fixedly mount said at least one fluid treatment cartridge upon said at least one head member without the need for auxiliary tools and fasteners.

2. The fluid treatment system as set forth in claim 1, further comprising:
a pair of check valves disposed within said at least one head member and automatically movable to respective CLOSED positions for blocking fluid flow through said at least one head member when said at least one fluid treatment cartridge is not mounted upon said at least one head member, and automatically movable to OPEN positions for permitting fluid flow through said at least one head member when said at least one fluid treatment cartridge is mounted upon said at least one head member.

3. The fluid treatment system as set forth in claim 2, wherein:
said pair of check valves are disposed within said at least one head member at diametrically opposed positions with respect to each other; and
said at least one fluid treatment cartridge has an elliptically-shaped cam member fixedly mounted thereon such that when said at least one fluid treatment cartridge is initially inserted into said at least one head member, a minor axis portion of said elliptically-shaped cam member will be aligned with a locus extending between said pair of diametrically opposed check valves so as not to engage said pair of diametrically opposed check valves whereby said pair of diametrically opposed check valves are disposed at said CLOSED positions, whereas when said at least one fluid treatment cartridge is rotated 90° with respect to said at least one head member such that said quarter-turn locking mechanisms engage each other so as to fixedly secure said at least one fluid treatment cartridge upon said at least one head member, a major axis portion of said elliptically-shaped cam member will be aligned with said locus extending between said pair of diametrically opposed check valves whereby opposite longitudinal end portions of said elliptically-shaped cam member will engage said pair of diametrically opposed check valves and move said pair of diametrically opposed check valves to their OPEN positions.

4. The fluid treatment system as set forth in claim 1, wherein:
said fluid inlet is integrally formed upon a first end connector; and
said fluid outlet is integrally formed upon a second end connector.

5. The fluid treatment system as set forth in claim 4, wherein:
said first and second end connectors are identical to each other and are interchangeable with each other whereby said first end connector, containing said fluid inlet, can effectively serve as said second end connector wherein said fluid inlet becomes said fluid outlet, and said second end connector, containing said fluid outlet, can effectively serve as said first end connector wherein said fluid outlet becomes said fluid inlet.

6. The fluid treatment system as set forth in claim 1, wherein:
said at least one fluid treatment cartridge comprises an external housing which has longitudinally extending ribbed structures disposed thereon for facilitating handling of said at least one fluid treatment cartridge even when said external housing becomes wet.

7. The fluid treatment system as set forth in claim 4, wherein:
said first and second end connectors are mounted onto opposite sides of said at least one head member by male/female snap-fitting latching members respectively formed upon said first and second end connectors, and said at least one head member.

8. A modular multimedia fluid treatment system, comprising:
at least two head members;
at least two fluid treatment cartridges respectively mounted upon said at least two head members;
a fluid inlet fluidically connected to a first one of said at least two head members for introducing a fluid, to be treated, into said first one of said at least two head members;
a first fluid conduit defined within said first one of said at least two head members for conducting the fluid, to be treated, from said first one of said at least two head members into a first one of said at least two fluid treatment cartridges;
a second fluid conduit for conducting treated fluid from said first one of said at least two fluid treatment cartridges into said second one of said at least two head members;
a third fluid conduit defined within said second one of said at least two head members for conducting treated fluid from said second one of said at least two head members into a second one of said at least two fluid treatment cartridges;
a fluid outlet fluidically connected to said second one of said at least two head members for conducting treated fluid out from said second one of said at least two head members; and
cooperating quarter-turn locking members defined upon both of said at least two head members and both of said at least two fluid treatment cartridges so as to respectfully fixedly mount said at least two fluid treatment cartridges upon said at least two head members without the need for auxiliary tools and fasteners.

9. The fluid treatment system as set forth in claim 8, further comprising:
a pair of check valves respectively disposed within each one of said at least two head members and automatically movable to respective CLOSED positions for blocking fluid flow through said at least two head members when said at least two fluid treatment cartridges are not respectively mounted upon said at least two head members, and automatically movable to OPEN positions for permitting fluid flow through said at least two head members when said at least two fluid treatment cartridges are respectively mounted upon said at least two head members.

10. The fluid treatment system as set forth in claim 9, wherein:
said pair of check valves are respectively disposed within said at least two head members at diametrically opposed positions with respect to each other; and
said at least two fluid treatment cartridges respectively have an elliptically-shaped cam member fixedly mounted thereon such that when said at least two fluid treatment cartridges are respectively initially inserted into said at least two head members, a minor axis portion of said elliptically-shaped cam member will be aligned with a locus extending between said pair of diametrically opposed check valves so as not to engage said pair of diametrically opposed check valves whereby said pair of diametrically opposed check valves are disposed at said CLOSED positions, whereas when said at least two fluid treatment cartridges are respectively rotated 90° with respect to said at least two head members such that said quarter-turn locking mechanisms engage each other so as to respectively fixedly secure said at least two fluid treatment cartridges upon said at least two head members, a major axis portion of said elliptically-shaped cam member will be aligned with said locus extending between said pair of diametrically opposed check valves whereby opposite longitudinal end portions of said elliptically-shaped cam member will engage said pair of diametric-ally opposed check valves and move said pair of diametrically opposed check valves to their OPEN positions.

11. The fluid treatment system as set forth in claim 8, wherein:
said fluid inlet is integrally formed upon a first end connector; and
said fluid outlet is integrally formed upon a second end connector.

12. The fluid treatment system as set forth in claim 11, wherein:
said first and second end connectors are identical to each other and are interchangeable with each other whereby said first end connector, containing said fluid inlet, can effectively serve as said second end connector wherein said fluid inlet becomes said fluid outlet, and said second end connector, containing said fluid outlet, can effectively serve as said first end connector wherein said fluid outlet becomes said fluid inlet.

13. The fluid treatment system as set forth in claim 8, wherein:
each one of said at least two fluid treatment cartridges comprises an external housing which has longitudinally extending ribbed structures disposed thereon for facilitating handling of said at least two fluid treatment cartridges even when said external housings become wet.

14. The fluid treatment system as set forth in claim 11, wherein:
said first and second end connectors are mounted onto side portions of said at least two head members by male/female snap-fitting latching members respectively formed upon said first and second end connectors, and said at least two head members.

15. A modular multimedia fluid treatment system, comprising:
at least three head members;
at least three fluid treatment cartridges respectively mounted upon said at least three head members;
a fluid inlet fluidically connected to a first one of said at least three head members for introducing a fluid, to be treated, into said first one of said at least three head members;
a first fluid conduit defined within said first one of said at least three head members for conducting the fluid, to be treated, from said fluid inlet into a first one of said at least three fluid treatment cartridges;
a second fluid conduit for conducting fluid out from said first one of said at least three fluid treatment cartridges into a second one of said at least three head members;
a third fluid conduit defined within said second one said at least three head members for conducting treated fluid from said second one of said at least three head members into a second one of said at least three fluid treatment cartridges;
a fourth fluid conduit for conducting fluid out from said second one of said at least three fluid treatment cartridges into a third one of said at least three head members;
a fifth fluid conduit defined within said third one of said at least three head members for conducting treated fluid out from said third one of said at least three head members into a third one of said at least three fluid treatment cartridges;
a fluid outlet fluidically connected to said third one of said at least three head members for conducting treated fluid out from said third one of said at least three head members; and
cooperating quarter-turn locking members defined upon all of said at least head members and all of said at least three fluid treatment cartridges so as to respectfully fixedly mount said at least three fluid treatment cartridges upon said at least three head members without the need for auxiliary tools and fasteners.

16. The fluid treatment system as set forth in claim 15, further comprising:
a pair of check valves respectively disposed within each one of said at least three head members and automatically movable to respective CLOSED positions for blocking fluid flow through said at least three head members when said at least three fluid treatment cartridges are not respectively mounted upon said at least three head members, and automatically movable to OPEN positions for permitting fluid flow through said at least three head members when said at least three fluid treatment cartridges are respectively mounted upon said at least three head members.

17. The fluid treatment system as set forth in claim 15, wherein:
said pair of check valves are respectively disposed within said at least three head members at diametrically opposed positions with respect to each other; and
said at least three fluid treatment cartridges respectively have an elliptically-shaped cam member fixedly mounted thereon such that when said at least three fluid treatment cartridges are respectively initially inserted into said at least three head members, a minor axis portion of said elliptically-shaped cam member will be aligned with a locus extending between said pair of diametrically opposed check valves so as not to engage said pair of diametrically opposed check valves whereby said pair of diametrically opposed check valves are disposed at said CLOSED positions, whereas when said at least three fluid treatment cartridges are respectively rotated 90° with respect to said at least three head members such that said quarter-turn locking mechanisms engage each other so as to respectively fixedly secure said at least three fluid treatment cartridges upon said at least three head members, a major axis portion of said elliptically-shaped cam member will be aligned with said locus extending between said pair of diametrically opposed check valves whereby opposite longitudinal end portions of said elliptically-shaped cam member will engage said pair of diametrically opposed check valves and move said pair of diametrically opposed check valves to their OPEN positions.

18. The fluid treatment system as set forth in claim 15, wherein:
said fluid inlet is integrally formed upon a first end connector; and
said fluid outlet is integrally formed upon a second end connector.

19. The fluid treatment system as set forth in claim 18, wherein:
said first and second end connectors are identical to each other and are interchangeable with each other whereby said first end connector, containing said fluid inlet, can effectively serve as said second end connector wherein said fluid inlet becomes said fluid outlet, and said second end connector, containing said fluid outlet, can effectively serve as said first end connector wherein said fluid outlet becomes said fluid inlet.

20. The fluid treatment system as set forth in claim 15, wherein:
each one of said at least three fluid treatment cartridges comprises an external housing which has longitudinally extending ribbed structures disposed thereon for facilitating handling of said at least three fluid treatment cartridges even when said external housings become wet.

21. The fluid treatment system as set forth in claim 15, wherein:
a first one of said at least three fluid treatment cartridges comprises a prefilter cartridge;
a second one of said at least three fluid treatment cartridges comprises a fluid storage cartridge; and
a third one of said at least three fluid treatment cartridges comprises a chemical reduction/fluid treatment cartridge.

22. The fluid treatment system as set forth in claim 21, wherein:
a flow diverter and a flow director are incorporated within said fluid treatment system such that when said first prefilter cartridge is backwashed so as to clean filter elements within said prefilter cartridge, enhanced fluid back flow is achieved through the development of at least one low-pressure, high velocity fluid flow region.

23. The fluid treatment system as set forth in claim 15, further comprising:
an intermediate connector fluidically connecting said first one of said at least three head members to said second one of said at least three head members and comprising a solenoid-controlled reverse flow valve for providing reverse fluid flow within said fluid treatment system so as to backwash said first prefilter cartridge.

24. The fluid treatment system as set forth in claim 18, wherein:
said first and second end connectors are mounted onto side portions of said first and third ones of said at least three head members by male/female snap-fitting latching members respectively formed upon said first and second end connectors, and said first and third ones of said at least three head members.

25. The fluid treatment system as set forth in claim 22, wherein:
said intermediate connector is mounted onto side portions of said first and second ones of said at least three head members by male/female snap-fitting latching members respectively formed upon said intermediate connector, and said first and second ones of said at least three head members.
